(19) United States
(12) Patent Application Publication
(10) Pub. No.: US 2024/0392400 A1
(43) Pub. Date: Nov. 28, 2024

(54) METHOD FOR REFINING MOLTEN IRON

(71) Applicant: Industry-Academic Cooperation Foundation, YONSEI UNIVERSITY, Seoul (KR)

(72) Inventors: Gyo Khang PARK, Seoul (KR); Il SOHN, Seoul (KR)

(21) Appl. No.: 18/672,843

(22) Filed: May 23, 2024

(30) Foreign Application Priority Data
May 25, 2023 (KR) 10-2023-0067332

(51) Int. Cl. C21C 7/068; C21B 13/00; C21B 13/12

(52) U.S. Cl. CPC C21C 7/068; C21B 13/0006; C21B 13/12; C21B 2100/40; C21C 2100/04

(57) ABSTRACT

In an embodiment, gas emitted during DRI processing and melting is collected and blown in refining, and gas emitted from the refining is collected and used in DRI processing, so that it is possible to circulate gas input to and emitted from each process in a DRI-Smelter-BOF (Basic Oxygen Furnace) scheme and achieve process optimization.

### CROSS-REFERENCE TO RELATED APPLICATION(S)

This application claims priority to Korean Patent Application No. 10-2023-0067332, filed on May 25, 2023, the entire disclosure of which is incorporated herein for all aspects.

### BACKGROUND

The disclosure relates to a method for refining molten iron and, more specifically, to a method for performing decarbonization refining using exhaust gas generated in a steelmaking process.

The world is conducting various research activities to achieve so-called carbon neutrality, which is to reduce carbon emissions as much as possible and increase absorption to reduce actual carbon emissions to “0” level.

In order to respond to the implementation of carbon neutrality and establishment of related policies in countries around the world, various policies and strategies are being implemented domestically. In particular, a special solution is needed as greenhouse gas emissions in the steel sector account for the highest emissions with reference to a single industry.

In the case of a hydrogen reduction steelmaking technology, which has recently been attracting attention as a decarbonization technology, the development has been made focusing on the production of hydrogen-reduced iron based on high-grade raw materials (DR-grade) with an iron (Fe) content of 67% or more and the electric arc furnace (EAF) melting process.

However, high-quality raw materials account for a very small proportion of the total raw material supply, and due to concerns about limited supply and demand, the development of a technology for utilizing low-quality raw materials has become an issue. When using low-quality raw materials, problems such as a reduced reduction rate and a decreased yield due to the increased gangue content are anticipated. Therefore, a plan to introduce hydrogen reduction direct reduction iron (DRI) and Electric Smelter (melting+implementation of further reduction by carbon material+carbon capture, utilization, and storage (CCUS) linkage) instead of the electric furnace schemes is being considered.

Therefore, it is necessary to devise an efficient operation plan in preparation for implementing such a process.

### SUMMARY

According to an aspect of the disclosure, in order to circulate gas input to and emitted from each process in a DRI-Smelter-BOF (basic oxygen furnace) scheme, gas emitted during DRI processing and melting is collected and blown in refining, and gas emitted from the refining is collected and used in DRI processing, so that process optimization is achieved.

The aspect of the disclosure is not limited to that mentioned above, and other aspects not mentioned will be clearly understood by those skilled in the art from the description below.

According to an embodiment of the disclosure, provided is a method for refining molten iron through circulation of exhaust gas, the method including: preparing a raw material; reducing the raw material through Direct Reduction Iron (DRI) processing; inputting a carbon material into the reduced raw material to perform melting and further reduction; separating and collecting CO₂ and H₂O gas from exhaust gas generated in the Direct Reduction Iron (DRI) processing and the melting and further reduction; performing decarbonization refining by blowing the collected CO₂ and H₂O gas into molten iron; and collecting CO and H₂ gas generated in the decarbonization refining and reusing the gas in the Direct Reduction Iron (DRI) processing.

The melting and further reduction may be performed through electric smelting (electric smelter).

The separating and collecting of the CO₂ and H₂O gas may be performed through physical adsorption or chemical absorption.

The CO₂ and H₂O gas may further include O₂ gas.

According to another embodiment of the disclosure, provided is molten iron according to the method for refining molten iron through circulation of exhaust gas described above.

According to another embodiment of the disclosure, provided is a system device for reduction through circulation of exhaust gas, the system device including: a raw material input unit for inputting a raw material; a raw material reduction unit that reduces the raw material; a melting unit that melts and further reduces the reduced raw material; a collecting unit that separates and collects CO₂ and H₂O gas from exhaust gas generated by the melting and further reduction; and a refining unit that performs decarbonization refining by blowing the separated and collected CO₂ and H₂O gas into molten iron.

The raw material reduction unit may reduce a raw material through Direct Reduction Iron (DRI) processing.

The melting unit may be performed through electric smelting (electric smelter).

According to an embodiment of the disclosure, gas emitted during DRI processing and melting is collected and blown in refining, and gas emitted from the refining is collected and used in DRI processing, so that it is possible to circulate gas input to and emitted from each process in a DRI-Smelter-BOF (Basic Oxygen Furnace) scheme and achieve process optimization.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawing, in which:

FIG. 1 is a flow chart showing a method for refining molten iron through circulation of exhaust gas.

### DETAILED DESCRIPTION

Hereinafter, the disclosure will be described with reference to the accompanying drawings. However, the disclosure may be implemented in various different forms and, therefore, is not limited to the examples described herein. In order to clearly explain the disclosure in the drawings, portions unrelated to the description are omitted, and similar portions are given similar reference numerals throughout the specification.

Throughout the specification, when a portion is said to be “connected (linked, contacted, combined)” with another portion, this includes not only a case of being “directly connected” but also a case of being “indirectly connected” with another member in between. In addition, when a portion is said to “include” a certain component, this does not mean that other components are excluded, but that other components may be added, unless specifically stated to the contrary.

The terms used herein are merely used to describe specific embodiments and are not intended to limit the disclosure. Singular expressions include plural expressions unless the context clearly dictates otherwise. In this specification, it should be understood terms such as “include” or “have” are to designate the presence of features, numbers, steps, operations, components, parts, or combinations thereof described in the specification, but are not to exclude in advance the possibility of the presence or addition of one or more other features, numbers, steps, operations, components, parts, or combinations thereof.

Hereinafter, embodiments of the disclosure will be described in detail with reference to the accompanying drawings.

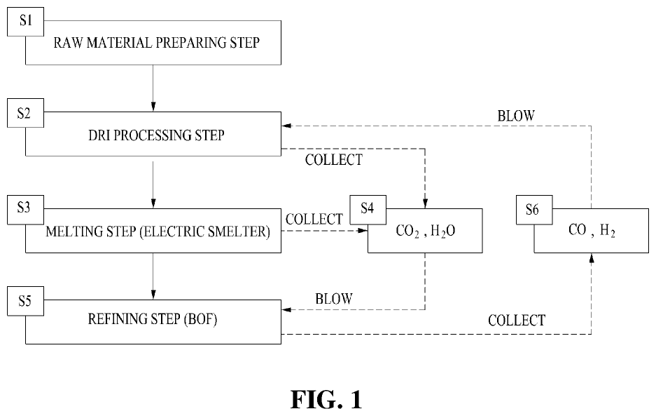

FIG. 1 is a flow chart showing a method for refining molten iron through circulation of exhaust gas.

Referring to FIG. 1, a method for refining molten iron through circulation of exhaust gas according to an embodiment of the disclosure will be described.

According to an embodiment of the disclosure, a method for refining molten iron through circulation of exhaust gas may include: (S1) preparing a raw material; (S2) reducing the raw material through Direct Reduction Iron (DRI) processing; (S3) inputting a carbon material into the reduced raw material to perform melting and further reduction; (S4) separating and collecting CO₂ and H₂O gas from exhaust gas generated in the Direct Reduction Iron (DRI) processing and the melting and further reduction; (S5) performing decarbonization refining by blowing the collected CO₂ and H₂O gas into molten iron; and (S6) collecting CO and H₂ gas generated in the decarbonization refining and reusing the gas in the Direct Reduction Iron (DRI) processing.

The first step is S1, which is preparing a raw material. In S1, low-grade raw materials (Fe content less than 67%) are prepared. High-quality raw materials account for a very small proportion of the total raw material supply, and due to concerns about limited supply and demand thereof, research is being conducted on ways to utilize low-quality raw materials, lower a reduction rate, reduce a yield due to increased gangue content, and the like.

The next is S2, which is reducing the raw material through Direct Reduction Iron (DRI) processing. A DRI process is a technology that produces iron sources by reducing iron ore in a solid state using reducing gas (CO, H). The raw material prepared in S1 is directly reduced through DRI processing in S2. When conventional high-grade raw materials are used, the amount of unreduced iron oxide after DRI processing is small, but when low-grade raw materials are used, the amount of unreduced iron oxide is large, which increases electricity consumption and the amount of slag. Therefore, in addition to DRI processing, it is necessary to perform melting and further reduction on input carbon materials such as coke in an electric smelter.

The next is S3, which is inputting a carbon material into the reduced raw material to perform melting and further reduction. S3 may be performed through electric smelting (electric smelter). When using low-quality raw materials, in order to solve problems such as a reduced reduction rate and a decreased yield due to an increased gangue content, hydrogen reduction DRI, melting, and further reduction by a carbon material instead of the electric furnace scheme are performed.

The next is S4, which is separating and collecting CO₂ and H₂O gas from exhaust gas generated in the DRI processing and the melting and further reduction. The separating and collecting of the CO₂ and H₂O gas may be performed by physical adsorption or chemical absorption. However, the scheme is not limited thereto.

The CO₂ and H₂O gas may further include O₂ gas. In the decarbonization refining, O₂ refining is possible in addition to CO₂ refining. In conventional O₂ refining, CO gas is no longer generated at the end of decarbonization refining.

The next is S5, which is performing decarbonization refining by blowing the collected CO₂ and H₂O gas into molten iron. Separated and collected CO₂ and H₂O gas may be input and undergo decarbonization refining, so as to generate CO and H₂ gas. After carbon and impurities are removed, CO₂ gas oxidizes Fe to produce FeO and Fe₂O₃, and CO gas continues to be generated.

The next is S6, which is collecting CO and H₂ gas generated in the decarbonization refining and reusing the gas in the Direct Reduction Iron (DRI) processing. The gas emitted during DRI processing (S2) and melting (S3) is collected and blown in refining, and the gas emitted from the refining is collected and used in DRI processing, so that it is possible to achieve process optimization.

Hereinafter, molten iron according to another embodiment of the disclosure will be described.

Molten iron according to an embodiment of the disclosure may include molten iron that has undergone the refining through circulation of exhaust gas. Molten iron that has gone through DRI processing has fewer impurities and may be used as a substitute for high-quality steel scrap. After carbon and impurities are removed, CO₂ gas oxidizes Fe to produce FeO and Fe₂O₃.

Hereinafter, a system device for reduction through circulation of exhaust gas according to another embodiment of the disclosure will be described.

A system device for reduction through circulation of exhaust gas may include: a raw material input unit for inputting a raw material; a raw material reduction unit that reduces the raw material; a melting unit that melts and further reduces the reduced raw material; a collecting unit that separates and collects CO₂ and H₂O gas from exhaust gas generated by the melting and further reduction; and a refining unit that performs decarbonization refining by blowing the separated and collected CO₂ and H₂O gas into molten iron.

Low-grade raw materials (Fe content less than 67%) are input through the raw material input unit. High-quality raw materials account for a very small proportion of the total raw material supply, and due to concerns about limited supply and demand thereof, research is being conducted on ways to utilize low-quality raw materials, lower a reduction rate, reduce a yield due to increased gangue content, and the like.

The raw material reduction unit may reduce raw materials through Direct Reduction Iron (DRI) processing. Directly reduced iron may be broadly divided into three types: Direct Reduction Iron (DRI), Hot Briquetted Iron (HBI), and Iron Carbide. Among these, the most widely used is DRI, which is produced by reducing iron ore using denatured natural gas or directly inputting coal.

The melting unit may be performed through electric smelting (electric smelter). In order to solve problems such as a reduced reduction rate and a decreased yield due to an increased gangue content, which occur when using low-quality raw materials, hydrogen reduction DRI and Electric Smelter (melting+implementation of further reduction by carbon material+carbon capture, utilization, and storage (CCUS) linkage) schemes instead of the electric furnace scheme are utilized. In this case, CO₂ or the like generated by the use of carbon reducing agents in an electric smelter process is likely to be reused in a decarbonization refining reaction, and thus CO₂ gas should be separately collected for use.

The collecting unit separates and collects CO₂ and H₂O gas from exhaust gas generated according to the input of a carbon material. The collecting of the CO₂ and H₂O gas may be performed by physical adsorption or chemical absorption. However, the scheme is not limited thereto.

In the refining unit, the separated and collected CO₂ and H₂O gas may be input into molten iron and undergo decarbonization refining, so as to generate CO and H₂ gas. By collecting the generated CO and H₂ gas to be reused in the DRI processing, it is possible to ultimately achieve process optimization for the refining of molten iron through circulation of exhaust gas.

The description of the disclosure described above is for illustrative purposes, and those skilled in the art will understand that the disclosure is easily modifiable into other specific forms without changing the technical idea or essential features of the disclosure. Therefore, the examples described above should be understood in all respects as illustrative and not restrictive. For example, each component described as single may be implemented in a distributed manner, and similarly, components described as distributed may also be implemented in a combined form.

The scope of the disclosure is indicated by the claims described below, and all changes or modified forms derived from the meaning and scope of the claims and their equivalent concepts should be construed as being included in the scope of the disclosure.

What is claimed is:

1. A method for refining molten iron through circulation of exhaust gas, the method comprising:
preparing a raw material;
reducing the raw material through Direct Reduction Iron (DRI) processing;
inputting a carbon material into the reduced raw material to perform melting and further reduction;
separating and collecting CO₂ and H₂O gas from exhaust gas generated in the Direct Reduction Iron (DRI) processing and in the melting and further reduction;
performing decarbonization refining by blowing the collected CO₂ and H₂O gas into molten iron; and
collecting CO and H₂ gas generated in the decarbonization refining and reusing the gas in the Direct Reduction Iron (DRI) processing.

2. The method of claim 1, wherein the melting and further reduction are performed through electric smelting or by an electric smelter.

3. The method of claim 1, wherein the separating and collecting of the CO₂ and H₂O gas are performed through physical adsorption or chemical absorption.

4. The method of claim 1, wherein the CO₂ and H₂O gas further comprise O₂ gas.

5. Molten iron refined according to the method of claim 1.

6. A system device for reduction through circulation of exhaust gas, the system device comprising:
a raw material input unit to input a raw material;
a raw material reduction unit to reduce the raw material;
a melting unit to melt and further reduce the reduced raw material;
a collecting unit to separate and collect CO₂ and H₂O gas from exhaust gas generated by the melting and further reduction; and
a refining unit to perform decarbonization refining by blowing the separated and collected CO₂ and H₂O gas into molten iron.

7. The system device of claim 6, wherein the raw material reduction unit is configured to reduce a raw material through Direct Reduction Iron (DRI) processing.

8. The system device of claim 6, wherein the melting is performed through electric smelting or by an electric smelter.
